(19) United States
(12) Patent Application Publication
(10) Pub. No.: US 2002/0110339 A1
(43) Pub. Date: Aug. 15, 2002

(54) Hybrid premises cable

(76) Inventor: Larry E. Dittmann, Middletown, PA (US)

Correspondence Address: Bruce J. Wolstoncroft, Esquire, Barley, Snyder, Senft & Cohen, LLC, 126 East King Street, Lancaster, PA, 17602, US

(21) Appl. No.: 09/781,856

(22) Filed: Feb. 12, 2001

(51) Int. Cl. G02B 6/44

(52) U.S. Cl. 385/101

(57) ABSTRACT

This invention provides an improved unshielded twisted pair cable for indoor premises use. The improved cable has a plurality of twisted pair electrical conductors positioned within an outer jacket along with the fiber-optic element. The outer jacket and insulative layers surrounding each unshielded twisted pair cable may be selected to be low toxicity, low smoke for plenum use. The twist lengths of the twisted pair electrical conductors are varied with respect to each other within the cable.

### FIELD OF THE INVENTION

The invention is related generally to cables and more specifically to a hybrid cable having both light transmission and electrical transmission capabilities.

### BACKGROUND OF THE INVENTION

Structured wiring systems for new construction have been designed to allow automated controls and advance communications systems within a premises. The structured wiring systems allow the capability to control lighting, climate, any electrical device from either within the premises or from a remote location. The structured wiring systems also allow for advanced communications systems to include services such as local area networks (LAN), wide area networks (WAN), various satellite communications services including television, audio services, and data services such as the Internet. A typical structured wiring system include various inputs to receive each of the services and a distribution network for distributing any of the selected services to selected locations within the premises.

A typical structured wiring system is commercially available by On-Q technologies. This system utilizes both coaxial and category 5 unshielded twisted pair (UTP) cabling for receiving the services and for distribution of the services within the premises. Although category 5 UTP cable designed according to the Telecommunications Industry Association TIA/EIA 568A standard meets today's demands for such a communications network, it may not be capable of handling increased data rates and bandwidth requirements of future services. For example, LAN and WAN data rate and bandwidth requirements are ever-increasing. Wireless and satellite communications services are becoming more advanced and require increased bandwidth. The increased data rates come with a need for better signal isolation, electromagnetic interference control, and improved attenuation characteristics. For example, category 5 UTP cable is specified at frequencies up to 100 MHz and gives a maximum attenuation of 22 dB per 100 meters of cable at 100 Mhz.

A problem exists in that while it is cost-effective to install a cable network during premises construction, it is generally cost prohibitive to rewire such a premises after construction. It is therefore desirable that these structured wiring systems be capable of handling the increased requirements of service providers in the future. Additional problems exist in that while it is desirable to add different transmission media such as coaxial cable, twisted pair cable, or fiber-optic cable to the network, any such hybrid cable must remain flexible and be capable of operation within the typical constraints of any premises. For example, cable is typically pulled through structural members and bent around corners within the structural members at various places within the system. Any hybrid cable must withstand the pulling operation and the bends required. TIA/EIA 568A requires the cable diameter to be less than 0.25 inch and the bend radius to be 1 inch. Also, since other electrical systems such as power and control are typically pulled in a similar fashion, the structured wiring system must be capable of avoiding electromagnetic interference generated by the other systems.

A hybrid cable is disclosed in related U.S. Pat. Nos. 5,917,977 and 6,049,647. That cable features a plurality of conductors, a water blocking section and a fiber-optic element. A problem exists with the cables disclosed in these patents in that while they are described as being suitable for indoor use, as shown, they do not conform with the standards specified in TIA/EIA 568A which requires a four twisted pair conductor configuration wherein the cable diameter is less than 0.25 inch and the bend radius is limited to 1 inch. Furthermore, the water blocking section and additional insulative layers provided between conductors causes an undesirable increase in the cable diameter along with an undesirable increase in bend radius.

### SUMMARY

The invention addresses these problems by providing a hybrid fiber-optic, twisted pair cable for use within a premises. The cable includes twisted pair conductors in a category 5 cable configuration according to TIA/EIA 568A with the addition of a fiber-optic transmission medium. The cable is configured to have an outer jacket housing four twisted pairs of conductors. Each twisted pair conductor is formed of a pair of wires each surrounded by the coded insulative layer. Also housed within the outer jacket is an optional filler and a fiber-optic element.

### BRIEF DESCRIPTION OF THE DRAWINGS

The invention will now be described by way of example with reference to the accompanying figures of which:

FIG. 1 is a cross sectional view of the hybrid cable according to the invention.

FIG. 2 is a three-dimensional view of the hybrid cable of FIG. 1.

### DETAILED DESCRIPTION OF THE PREFERRED EMBODIMENT

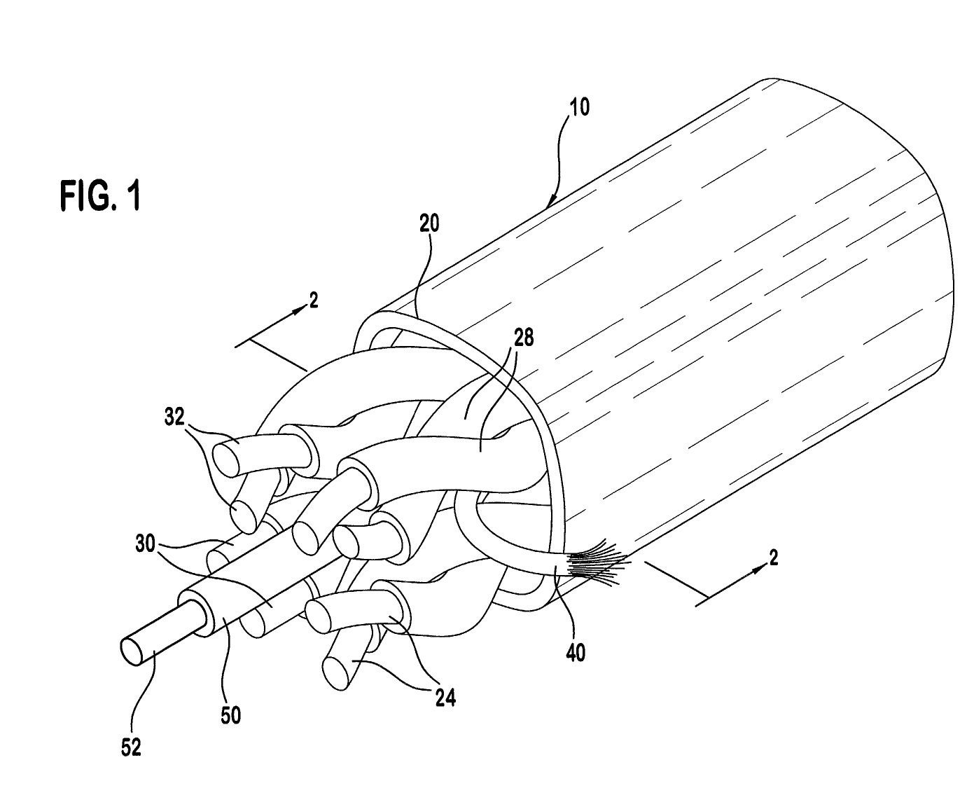

The invention will first be described generally with reference to FIG. 1. Like numerals will be used to describe like elements throughout the description. The cable 10 has an outer jacket 20 formed of a thermoplastic material. It should be understood by those reasonably skilled in the art that the outer jacket material may vary depending upon the application. For example, plenum rated cable will utilize a low toxicity, low smoke material for the outer jacket. Within the outer jacket, a plurality of twisted pair conductors 24, 28, 30, 32 are disposed at random locations. A filler or strength member 40 extends within the outer jacket 20 and is also disposed at a random location. A fiber-optic cable 50 extends within the outer jacket 20 and may be disposed either along the central axis of the outer jacket or at a random location similar to the twisted pair conductors 24, 28, 30, 32.

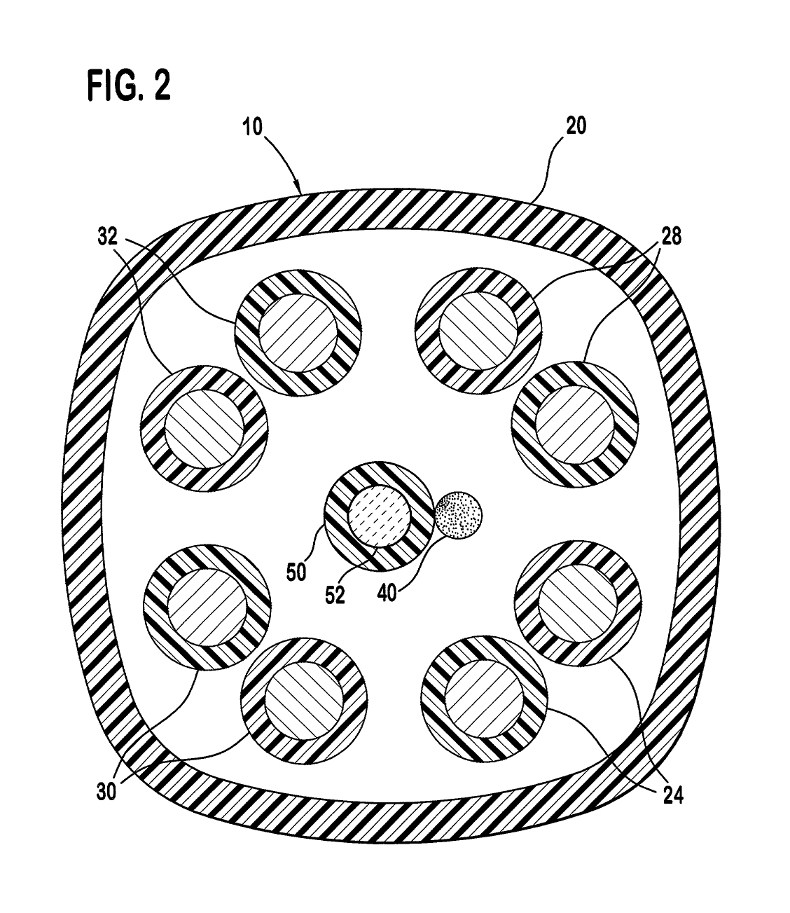

The invention will now be described in greater detail with reference to FIG. 2. This figure shows a cross sectional view of the cable 10 which is formed of a thermoplastic material outer jacket 20 enclosing the elements of the cable 10. Four pairs of UTP conductors 24, 28, 30, 32, a fiber-optic transmission media 50, and the strength member 40 are disposed within the outer jacket 20. Each UTP conductor 24, 28, 30, 32 preferably consists of a pair of 24 AWG solid wires each surrounded by a thermoplastic insulative coating in accordance with TIA/EIA 568A standards. A fiber-optic transmission media 50 consists of an optical transmission medium 52 which may be a glass or plastic fiber surrounded by a buffer 50. Other gauge wires may be utilized as necessary. For example, depending upon the size of the fiber-optic transmission media 52 and whether the strength member 40 is utilized, smaller wire gauges may be used while remaining within outer diameter limits specified by TIA/EIA 568A. The outer jacket may be formed of a low toxicity, low smoke material in applications where the cable 10 is rated for plenum applications. Similarly, low toxicity, low smoke materials may be utilize as the coating for each of the UTP conductors 24, 28, 30, 32 as well as the buffer 50 for the fiber-optic transmission media 52. Although the strength member 40 is shown within the outer jacket 20, this member can be avoided, as the mechanical characteristics of the conductors 24, 28, 30, 32 impart sufficient tensile and crush strength to eliminate the need for the strength member 40.

In order to comply with the cross talk requirements of category 5 UTP standards recited in TIA/EIA 568A, twist lengths must be selected to minimize cross talk. Twist length is defined in this application as the length between adjacent twists within a given UTP cable 24, 28, 30, 32. In order to reduce cross talk, the twist length between UTP cables is varied. Each cable is not required to have a different twist length from all of the others, however, at least one UTP cable must be of a different twist length than the other three. It is preferred however to vary the twist length of at least two of the UTP cables. Optionally, the twist length of any given UTP cable may vary over its length so that the relationship between its twist length and that of the remaining UTP cables is somewhat random.

Although FIG. 2 shows the fiber-optic transmission media 50 positioned in the center of the cable 10 and surrounded by the four UTP cables 24, 28, 30, 32, it's position may alternatively be random so that it is in place of one of the UTP cables instead of being positioned in the center. In applications where positioning of a fiber-optic transmission media 52 is critical to minimize the bend radius of the cable 10, each of the UTP cables 24, 28, 30, 32, and the fiber-optic transmission media 52 may be fixed by bonding within the outer jacket 20 at intervals along the length of the cable 10. In applications where it is unnecessary to minimize the bend radius of the cable 10, this expense of bonding may be eliminated.

An advantage of this invention is that a fiber-optic transmission media 52 is provided in a premises UTP cable which allows the communications system within the premises to be upgraded for increased bandwidth and increased bit rate communications. As necessary, the user may elect to upgrade current UTP cable system components with fiber-optic components having increased bandwidth and increased bit rate capabilities. This upgrade is facilitated by the present invention because no additional infrastructure wiring is necessary in order to switch from the UTP cable system to a fiber-optic system.

I claim:

1. An unshielded twisted pair cable comprising:
at least four pairs of twisted electrical conductors, each conductor being surrounded by an insulative coating, each of the four pairs of twisted electrical conductors having a twist length defined by the distance between twists in the respective pair, the twist length of at least one pair being different from the twist length of another pair;
at least one fiber-optic element positioned adjacent to an running along with the at least four pairs of twisted electrical conductors; and,
an outer jacket surrounding the twisted electrical conductors and the fiber-optic element.

2. The unshielded twisted pair cable of claim 1 further comprising a strength member disposed within the outer jacket.

3. The unshielded twisted pair cable of claim 1 wherein the at least four pairs of twisted electrical conductors surround the fiber-optic element.

4. The unshielded twisted pair cable of claim 1 wherein the at least four pairs of twisted electrical conductors and the fiber-optic element are located at random positions within the outer jacket.

5. The unshielded twisted pair cable of claim 1 where in the fiber-optic element is a buffered glass fiber.

6. The unshielded twisted pair cable of claim 1 wherein the fiber-optic element is a plastic fiber.

7. The unshielded twisted pair cable of claim 1 wherein the at least four pairs of twisted electrical conductors are bonded at several locations along a length of the cable.

8. The unshielded twisted pair cable of claim 1 wherein the outer jacket is formed of a low toxicity, low smoke material.

9. The unshielded twisted pair cable of claim 8 wherein each insulative coating is formed of a low toxicity, low smoke material.

10. An unshielded twisted pair cable for indoor premises use comprising:
four pairs of twisted electrical conductors each being disposed at random locations along a length of the cable, each conductor being surrounded by an insulative coating, each of the four pairs of twisted electrical conductors having a twist length defined by the distance between twists in the respective pair, the twist length of at least one pair being different from the twist length of another pair;
at least one fiber-optic element positioned adjacent to and running along the length of the cable with the four pairs of twisted electrical conductors; and,
an outer jacket surrounding the twisted electrical conductors and the fiber-optic element.

11. The unshielded twisted pair cable of claim 10 wherein the four pairs of twisted electrical conductors surround the fiber-optic element.

12. The unshielded twisted pair cable of claim 11 wherein the fiber-optic element is a buffered glass fiber.

13. The unshielded twisted pair cable of claim 11 wherein the fiber-optic element is a plastic fiber.

14. The unshielded twisted pair cable of claim 12 wherein the four pairs of twisted electrical conductors are bonded at several locations along a length of the cable.

15. The unshielded twisted pair cable of claim 13 wherein the four pairs of twisted electrical conductors are bonded at several locations along a length of the cable.

16. The unshielded twisted pair cable of claim 14 wherein the outer jacket is formed of a low toxicity, low smoke material.

17. The unshielded twisted pair cable of claim 15 wherein the outer jacket is formed of a low toxicity, low smoke material.

18. The unshielded twisted pair cable of claim 16 wherein each insulative coating is formed of a low toxicity, low smoke material.

19. The unshielded twisted pair cable of claim 17 wherein each insulative coating is formed of a low toxicity, low smoke material.

20. The unshielded twisted pair cable of claim 18 further comprising a strength member disposed within the outer jacket.

21. The unshielded twisted pair cable of claim 19 further comprising a strength member disposed within the outer jacket.
